(19) United States
(12) Patent Application Publication
(10) Pub. No.: US 2019/0124309 A1
(43) Pub. Date: Apr. 25, 2019

(54) PROJECTOR AND METHOD FOR CONTROLLING PROJECTOR

(71) Applicant: SEIKO EPSON CORPORATION, Tokyo (JP)

(72) Inventor: Hiroyuki ICHIEDA, MATSUMOTO-SHI (JP)

(73) Assignee: SEIKO EPSON CORPORATION, Tokyo (JP)

(21) Appl. No.: 16/166,461

(22) Filed: Oct. 22, 2018

(30) Foreign Application Priority Data
Oct. 23, 2017 (JP) 2017-204524

(51) Int. Cl. H04N 9/31; H04N 3/233; G06F 3/0354; G03B 21/14

(52) U.S. Cl. CPC H04N 9/3185; H04N 3/2335; G03B 21/147; G06F 3/0354; H04N 9/3182

(57) ABSTRACT

A projector includes: a projection unit which projects a projection image on a projection surface; a position detection unit which detects a designated position designated by a pointer on the projection surface; a movement detection unit which detects a movement of the pointer; and a correction unit which corrects a distortion of the projection image, based on the designated position and the movement.

### BACKGROUND

### 1. Technical Field

The present invention relates to a projector and a method for controlling a projector.

### 2. Related Art

JP-A-2003-304552 discloses a projector which can correct a distortion of a projection image on a projection surface. A user of this projector operates a remote controller to select a correction point whose position is to be corrected, from among points at the four corners of the projection image. The user then operates the remote controller to move the correction point. The correction point moves by a predetermined distance every time the remote controller is operated. The projector corrects the distortion of the projection image by moving the correction point.

With the projector disclosed in JP-A-2003-304552, for example, if the projection image has a large distortion, the remote controller needs to be operated a large number of times and it takes time to correct the distortion of the projection image. Therefore, operability is not high.

### SUMMARY

An advantage of some aspects of the invention is that a technique for easily correcting a distortion of a projection image is provided.

An aspect of a projector according to the invention includes: a projection unit which projects a projection image on a projection surface; a position detection unit which detects a designated position designated by a pointer on the projection surface; a movement detection unit which detects a movement of the pointer; and a correction unit which corrects a distortion of the projection image, based on the designated position and the movement.

With this configuration, a distortion of a projection image is corrected, based on a designated position designated by the pointer and a movement of the pointer. This enables the user to intuitively correct a distortion of a projection image, using the pointer. Thus, a distortion of a projection image can be easily corrected and operability is improved.

In the aspect of the projector, it is desirable that the correction unit decides a correction site in the projection image, based on the designated position, and corrects the position of the correction site, based on the movement, and thus corrects the distortion of the projection image.

This configuration enables the user to easily designate a correction site and correct the position of the correction site by using the pointer.

In the aspect of the projector, it is desirable that the projection image has a plurality of areas, that the areas include a candidate of the correction site, and that the correction unit specifies a designated area including the designated position from among the plurality of areas and decides a candidate of the correction site included in the designated area, as the correction site.

This configuration enables the user designate a correction site simply by designating the area including the correction site with the pointer, instead of directly designating the correction site with the pointer. Thus, a correction site can be designated easily.

It is desirable that the aspect of the projector further includes a display control unit which causes a display form of at least a part of the designated area to be different from a display form of an area that is different from the designated area, of the plurality of areas.

This configuration enables the user to easily visually recognize a designated area.

In the aspect of the projector, it is desirable that the correction unit decides a direction of shift of the correction site according to a direction of the movement, decides an amount of shift of the correction site according to a magnitude of the movement, and shifts the correction site by the amount of shift of the correction site in the direction of shift of the correction site.

This configuration enables adjusting the shift of a correction site according to the direction and magnitude of movement of the pointer.

In the aspect of the projector, it is desirable that the position detection unit detects the designated position at a first timing and that the movement detection unit detects the movement generated after the first timing.

With this configuration, the movement of the pointer is detected after the timing when the designated position designated by the pointer is detected. Thus, the user can designate a correction site and adjust the shift of the correction site in an intuitively intelligible order.

In the aspect of the projector, it is desirable that the first timing is a timing corresponding to when the pointer comes into contact with the projection surface.

This configuration enables the user to decide the timing of detecting a designated position by a simple operation of bringing the pointer into contact with the projection surface.

In the aspect of the projector, it is desirable that the first timing is a timing corresponding to when a state where the pointer is in contact with the projection surface has continued for a predetermined time.

With this configuration, a designated position is detected when the state where the pointer is in contact with the projection surface has continued for a predetermined time. Thus, it is possible to restrain detection of a designated position when the pointer temporarily comes into contact with the projection surface by accident.

In the aspect of the projector, it is desirable that the movement detection unit detects a movement of the pointer in a state where the pointer is in contact with the projection surface.

With this configuration, the user can shift the pointer in contact with the projection surface when adjusting the shift of a correction site, and can release the pointer from the projection surface when ending the adjustment. Thus, the user can intuitively adjust the shift of the correction site.

In the aspect of the projector, it is desirable that the movement detection unit detects a movement of an attitude of the pointer.

This configuration enables the user to adjust the shift of a correction site without bringing the pointer into contact with the projection surface. Thus, the user can correct a distortion of a projection image even in a circumstance where the user is away from the projection surface and therefore cannot touch the projection surface.

Another aspect of the projector according to the invention includes: a projection unit which projects a projection image on a projection surface; a position detection unit which detects a designated position designated by a pointer on the projection surface; a change detection unit which detects a change in the designated position; and a correction unit which corrects a distortion of the projection image, based on the designated position and the change in the designated position.

With this configuration, a distortion of a projection image is corrected, based on a designated position designated by the pointer and a change in the designated position. This enables the user to intuitively correct a distortion of a projection image, using the pointer. Thus, a distortion of a projection image can be easily corrected and operability is improved.

In the aspect of the projector, it is desirable that the correction unit decides a correction site in the projection image, based on the designated position, and corrects the position of the correction site, based on the change in the designated position, and thus corrects the distortion of the projection image.

This configuration enables the user to easily designate a correction site and correct the position of the correction site by using the pointer.

An aspect of a method for controlling a projector according to the invention includes: projecting a projection image on a projection surface; detecting a designated position designated by a pointer on the projection surface; detecting a movement of the pointer; and correcting a distortion of the projection image, based on the designated position and the movement.

With this configuration, a distortion of a projection image is corrected, based on a designated position designated by the pointer and a movement of the pointer. This enables the user to intuitively correct a distortion of a projection image, using the pointer. Thus, a distortion of a projection image can be easily corrected and operability is improved.

Another aspect of the method for controlling a projector according to the invention includes: projecting a projection image on a projection surface; detecting a designated position designated by a pointer on the projection surface; detecting a change in the designated position; and correcting a distortion of the projection image, based on the designated position and the change in the designated position.

With this configuration, a distortion of a projection image is corrected, based on a designated position designated by the pointer and a change in the designated position. This enables the user to intuitively correct a distortion of a projection image, using the pointer. Thus, a distortion of a projection image can be easily corrected and operability is improved.

### BRIEF DESCRIPTION OF THE DRAWINGS

The invention will be described with reference to the accompanying drawings, wherein like numbers reference like elements.

FIG. 1 shows a projector, a projection surface for a projection image from the projector, and a pointer according to a first embodiment to which the invention is applied.

FIG. 2 shows an example of a projection image after correction.

FIG. 3 schematically shows the configuration of the projector, the projection surface for a projection image from the projector, and the pointer.

FIG. 4 shows an example of an image pickup unit.

FIG. 5 shows a first pattern corresponding to first pattern information.

FIG. 6 shows a second pattern corresponding to second pattern information.

FIG. 7 shows a distortion correction pattern corresponding to distortion correction pattern information.

FIG. 8 is a flowchart for explaining calibration operation.

FIG. 9 shows an example of projection of the first pattern on the projection surface.

FIG. 10 shows an example of projection of the second pattern on the projection surface.

FIG. 11 is a flowchart for explaining image distortion correction in a distortion correction mode.

FIG. 12 shows a projection image of the distortion correction pattern on the projection surface.

FIG. 13 shows an example where an area as a designated area is highlighted.

FIG. 14 shows an example where the designated area is changed to an area.

FIG. 15 shows an example where the pointer is in contact with the projection surface.

FIG. 16 shows an example of correction of the projection image corresponding to a shift of the designated position.

FIG. 17 schematically shows the configuration of a projector according to modification to which the invention is applied.

### DESCRIPTION OF EXEMPLARY EMBODIMENTS

An embodiment of the invention will be described below with reference to the drawings. In the drawings, the dimension and scale of individual components are different from those of the actual components where appropriate. The embodiment described below is a preferred specific example of the invention. Therefore, the embodiment includes various technically preferable limitations. However, the scope of the invention is not limited to the embodiment unless any limitation of the invention is specifically described below.

### First Embodiment

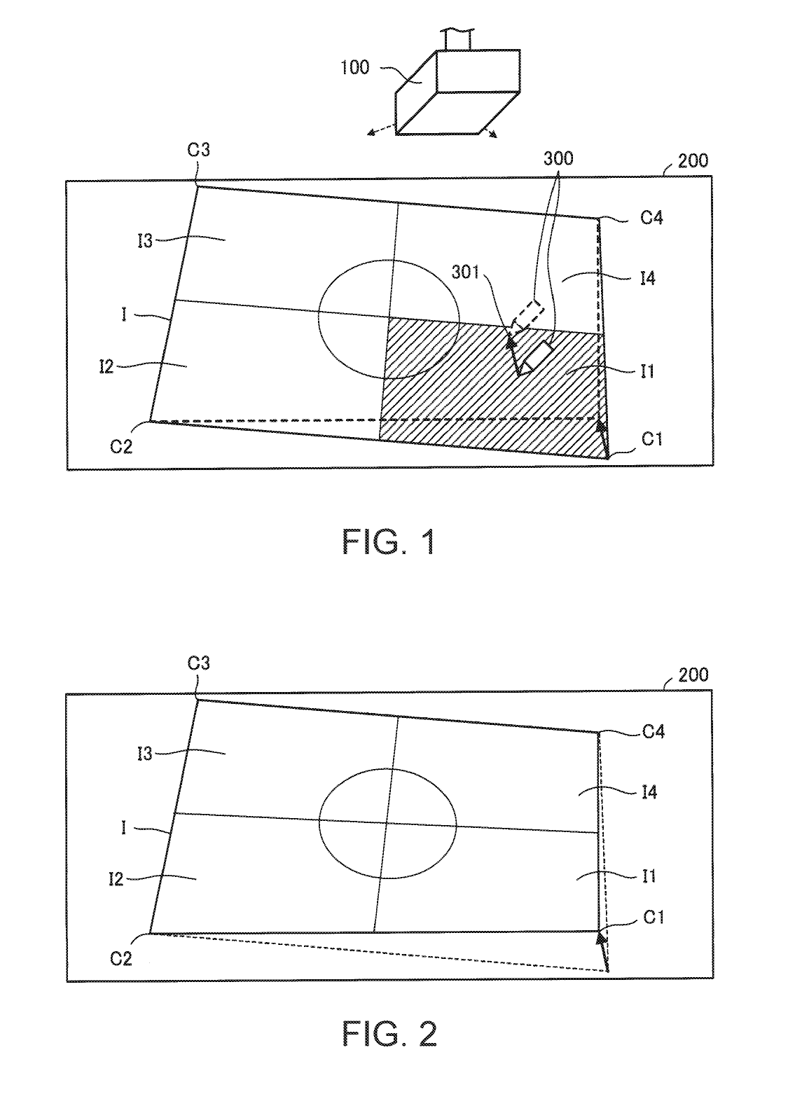

FIG. 1 shows a projector 100 according to a first embodiment to which the invention is applied. The projector 100 is suspended, for example, from a ceiling. The projector 100 may be placed on a conference table or the like, instead of being suspended from a ceiling. The projector 100 receives image information from an image supply device (not illustrated) such as a PC (personal computer) and projects a projection image corresponding to the image information onto a projection surface 200. The image supply device is not limited to a PC and can be changed where appropriate. The projection surface 200 is, for example, a screen or wall.

The projector 100 also projects, on the projection surface 200, an image (hereinafter also referred to as “projection image I”) used to correct a distortion of the projection image.

The projection image I includes four areas I1 to I4. The area I1 includes a point C1, of points C1 to C4 at the four corners. The area 12 includes the point C2. The area I3 includes the point C3. The area I4 includes the point C4. Each of the points C1 to C4 is an example of a candidate of correction site.

The projection image I is originally rectangular but may be distorted as shown in FIG. 1, depending on the positional relation between the projector 100 and the projection surface 200 and the shape of the projection surface 200.

The projection image I on the projection surface 200 is designated, for example, by a pointer 300. In this embodiment, a pen-type device is used as the pointer 300. A user holds the pointer 300 in a hand and thus uses the pointer 300. Hereinafter, a position designated by the pointer 300 on the projection surface 200 is also referred to as “designated position”.

The projector 100 corrects a distortion of the projection image I, based on a designated position designated by the pointer 300 and a movement of the pointer 300.

The projector 100 corrects a distortion of the projection image I, for example, as follows.

The projector 100 specifies an area (hereinafter also referred to as “designated area”) including a designated position designated by the pointer 300, from among the areas I1 to I4. In FIG. 1, the area I1 is specified as the designated area.

The projector 100 decides a point (candidate of correction site) included in the designated area, of the points C1 to C4, as a correction site. In FIG. 1, the point C1 is decided as the correction site.

The projector 100 starts detecting a movement of the pointer 300 when the pointer 300 comes into contact with the projection surface 200 in the state where the designated position designated by the pointer 300 is in the designated area. The projector 100 corrects the position of the correction site (in FIG. 1, point C1), based on the movement of the pointer 300, and thus corrects the distortion of the projection image I. FIG. 2 shows an example of the projection image I after correction. In the projection image I shown in FIG. 2, the position of the point C1 has shifted from its position in the projection image I shown in FIG. 1.

In FIG. 1, the contour of the projection image I after correction by shifting the point C1 is shown by dashed lines. In FIG. 2, the contour of the projection image I before correction is shown by dashed lines. An arrow in FIG. 1 indicates the movement of a distal end 301 of the pointer 300. An arrow in FIG. 2 indicates that the position of the point C1 has shifted, corresponding to the movement of the distal end 301 of the pointer 300.

The projector 100 highlights the designated area. For example, the projector 100 uses “blue” as the background color of the areas that are not the designated area, of the areas I1 to I4, and uses “green” as the background color of the designated area. The combination of background colors used for highlighting is not limited to “blue” and “green” and can be changed where appropriate. In FIG. 1, the designated area (area I1) is shaded in order to explain the highlighting of the designated area.

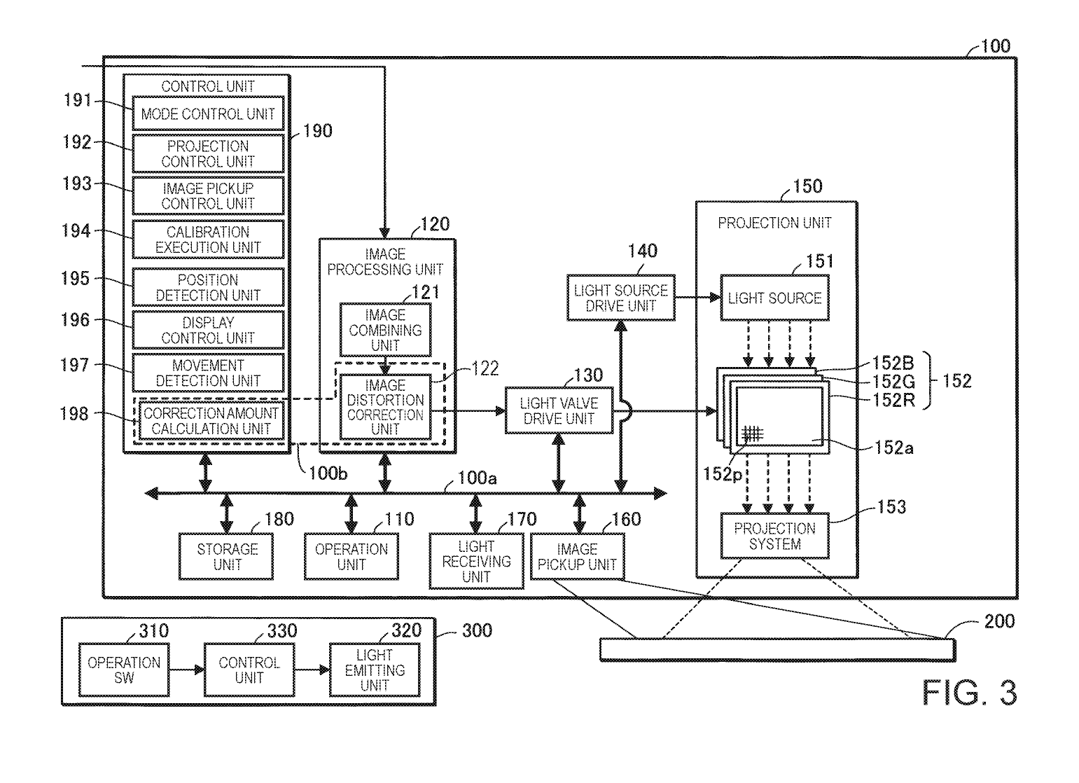

FIG. 3 schematically shows the projector 100, the projection surface 200, and the pointer 300.

The projector 100 includes an operation unit 110, an image processing unit 120, a light valve drive unit 130, a light source drive unit 140, a projection unit 150, an image pickup unit 160, a light receiving unit 170, a storage unit 180, a control unit 190, and a bus 100a. The operation unit 110, the image processing unit 120, the light valve drive unit 130, the light source drive unit 140, an image pickup unit 160, the light receiving unit 170, the storage unit 180, and the control unit 190 can communicate with each other via the bus 100a.

The operation unit 110 is, for example, various operations buttons and operation keys or a touch panel. The operation unit 110 receives an input operation by the user. The operation unit 110 may also be a remote controller which transmits information corresponding to an input operation by the user, wirelessly or via a cable. In this case, the projector 100 has a receiving unit which receives information transmitted from the remote controller. The remote controller has various operation buttons and operation keys or a touch panel to receive an input operation by the user.

The image processing unit 120 performs image processing of image information and thus generates an image signal. For example, the image processing unit 120 performs image processing of image information (hereinafter also referred to as “received image information”) received from an image supply device such as a PC and thus generates an image signal. The image processing unit 120 includes an image combining unit 121 and an image distortion correction unit 122. The image distortion correction unit 122 is also included in a correction unit 100b which corrects a distortion of a projection image. The image processing unit 120 is an IC (integrated circuit) such as an ASIC (application specific integrated circuit). The image processing unit 120 may be included in the control unit 190.

The image combining unit 121 combines a plurality of pieces of image information or outputs a single piece of image information. The image combining unit 121 combines or outputs image information written in an image memory (also referred to as “layer”). The layer may or may not be built in the image combining unit 121.

In this embodiment, the image combining unit 121 has a first layer and a second layer.

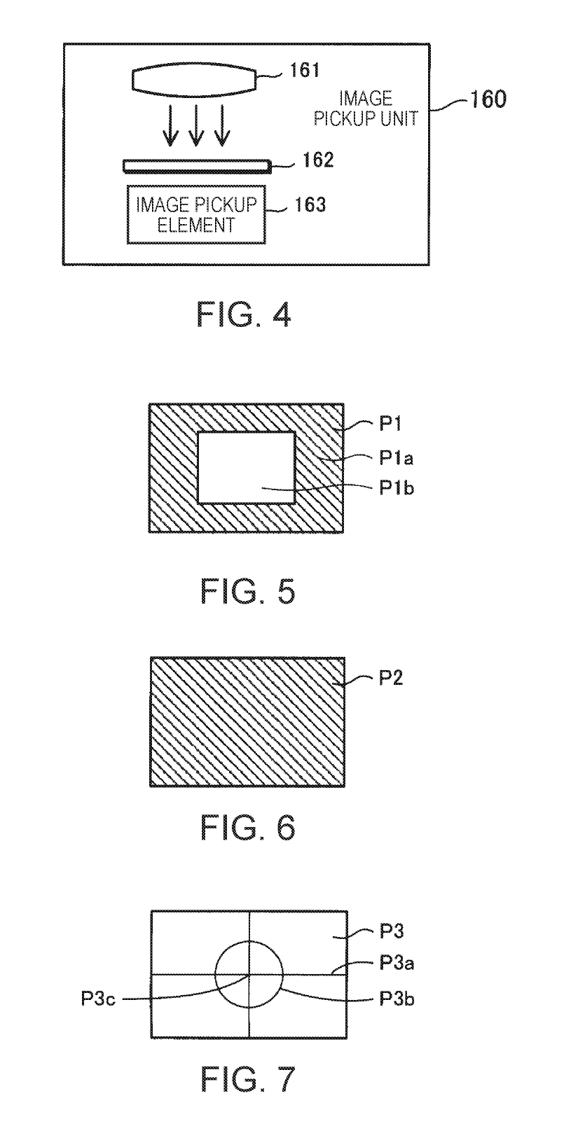

On the first layer, for example, received image information or the like is written. On the second layer, OSD image information representing an OSD (on-screen display) image is written. Also, calibration pattern information is written on the second layer. The calibration pattern information represents a pattern for calibration in which coordinates (for example, panel coordinates) on liquid crystal light valves 152 (see FIG. 3) of the projection unit 150 is made to correspond to coordinates (for example, CMOS coordinates) on an image pickup element 163 (see FIG. 4) of the image pickup unit 160 (hereinafter also referred to simply as “calibration”). Also, distortion correction pattern information representing a distortion correction pattern is written on the second layer. The projection image I shown in FIG. 1 is generated by projecting a distortion correction pattern.

Each of the received image information, the OSD image information, the calibration pattern information, and the distortion correction pattern information is image information.

If image information is written on the first layer and image information is not written on the second layer, the image combining unit 121 outputs the image information written on the first layer.

If image information is not written on the first layer and image information is written on the second layer, the image combining unit 121 outputs the image information written on the second layer.

If image information is written on both the first layer and the second layer, the image combining unit 121 combines the image information written on the first layer and the image information written on the second layer, thus generates combined image information, and outputs the combined image information (image information).

The image distortion correction unit 122 performs image distortion correction on the image information outputted from the image combining unit 121 and thus generates an image signal. The image distortion correction unit 122 performs image distortion correction on the image information, based on a parameter for image distortion correction. In this embodiment, keystone correction is used as image distortion correction. The parameter for image distortion correction is set by the control unit 190. The control unit 190 decides the parameter for image distortion correction, based on the designated position designated by the pointer 300 and the movement of the pointer 300. If the image distortion correction unit 122 does not perform image distortion correction on the image information outputted from the image combining unit 121, the image distortion correction unit 122 generates an image signal corresponding to the image information outputted from the image combining unit 121.

The light valve drive unit 130 drives the liquid crystal light valves 152 (152R, 152G, 152B) of the projection unit 150, based on the image signal generated by the image processing unit 120.

The light source drive unit 140 drives a light source 151 of the projection unit 150. For example, when the operation unit 110 receives a “power-on operation”, the light source drive unit 140 causes the light source 151 to emit light.

The projection unit 150 projects various projection images on the projection surface 200. The projection unit 150 includes the light source 151, three liquid crystal light valves 152 (152R, 152G, 152B) as an example of a light modulation device, and a projection system 153. In the projection unit 150, the liquid crystal light valves 152 modulate light emitted from the light source 151 and thus form projection image light (projection image), and the projection system 153 projects the projection image light in an enlarged form.

The light source 151 is a xenon lamp, ultra-high-pressure mercury lamp, LED (light emitting diode), or laser light source or the like. Light emitted from the light source 151 is reduced in luminance distribution variation by an optical integration system, not illustrated, and subsequently separated into color light components of the primary colors of light, red (R), green (G), and blue (B), by a color separation system, not illustrated. The R, G, B color light components become incident on the corresponding liquid crystal light valves 152R, 152G, 152B.

Each liquid crystal light valve 152 is made up of a liquid crystal panel or the like having a pair of transparent substrates with a liquid crystal enclosed between them. In the liquid crystal light valve 152, a rectangular pixel area 152a made up of a plurality of pixels 152p arranged in the form of a matrix is formed. In the liquid crystal light valve 152, a drive voltage can be applied to the liquid crystal at each pixel 152p. When the light valve drive unit 130 applies a drive voltage corresponding to the image signal inputted from the image processing unit 120 to each pixel 152p, each pixel 152p is set to a light transmittance corresponding to the image signal. Thus, the light emitted from the light source 151 is modulated by being transmitted through the pixel area 152a, and an image corresponding to the image signal is formed for each color light.

The images of the respective colors are combined, pixel 152p by pixel 152p, by a light combining system, not illustrated. Thus, projection image light (projection image I), which is color image light (color image), is generated. The projection image I is projected in an enlarged form on the projection surface 200 by the projection system 153.

The projection image I projected on the projection surface 200 may be distorted (see FIG. 1), depending on the positional relation between the projection surface 200 and the projector 100. In this embodiment, the user can correct the distortion of the projection image I, using the pointer 300.

The pointer 300 includes an operation switch (SW) 310, a light emitting unit 320, and a control unit 330.

The operation switch 310 is provided at the distal end 301 (see FIG. 1) of the pointer 300. The operation switch 310 is in on-state when the distal end 301 is in contact with the projection surface 200, and in off-state when the distal end 301 is not in contact with the projection surface 200.

The light emitting unit 320 is provided near the operation switch 310 (near the distal end 301). The light emitting unit 320 emits light. In this embodiment, the light emitting unit 320 emits infrared light.

The control unit 330 controls the light emitting unit 320, based on the state of the operation switch 310. The control unit 330 changes the light emission pattern of the light emitting unit 320 between when the operation switch 310 is in on-state and when the operation switch 310 is in off-state. Hereinafter, the light emission pattern when the operation switch 310 is in on-state is referred to as “first light emission pattern”, and the light emission pattern when the operation switch 310 is in off-state is referred to as “second light emission pattern”. Therefore, when the pointer 300 exists near the projection surface 200 without being in contact with the projection surface 200 (hovering state), the pointer 300 emits infrared light in the second light emission pattern.

The image pickup unit 160 picks up an image of the projection surface 200 and generates picked-up image information representing the picked-up image.

FIG. 4 shows an example of the image pickup unit 160. The image pickup unit 160 is a camera having an optical system 161 such as a lens, a filter 162 which transmits only infrared light of light condensed by the optical system 161, and an image pickup element 163 which converts the infrared light transmitted through the filter 162 into an electrical signal. The image pickup element 163 is, for example, a CCD (charged coupled device) image sensor or CMOS (complementary metal-oxide semiconductor) image sensor.

The image pickup unit 160 repeatedly picks up an image of the projection surface 200 and generates picked-up image information in time series. The image pickup unit 160 has the filter 162 and therefore can pick up an image of the light emitting unit 320 emitting infrared light when the pointer 300 exists on the projection surface 200. The projector 100 specifies the designated position designated by the pointer 300, based on the position of the infrared light in the picked-up image (specifically the position of the light emitting unit 320 emitting infrared light).

The light receiving unit 170 receives the infrared light emitted from the light emitting unit 320. In this embodiment, the light receiving unit 170 selectively receives infrared light in the first light emission pattern or infrared light in the second light emission pattern.

The projector 100 determines whether the pointer 300 is in contact with the projection surface 200 or not, based on the light emission pattern of the infrared light received by the light receiving unit 170.

The projector 100 may also specify the light emission pattern of the pointer 300, using the picked-up image information generated in time series, and determine whether the pointer 300 is in contact with the projection surface 200 or not, based on the light emission pattern. In this case, the light receiving unit 170 can be omitted.

To synchronize the light emission timing of the light emission pattern of the pointer 300 and the image pickup timing of the image pickup unit 160, the projector 100 may have a light emitting unit (not illustrated) which emits infrared light for synchronization, and the pointer 300 may have a light receiving unit (not illustrated) which receives the emitted infrared light for synchronization. In this case, the projector 100 can more securely specify the light emission pattern of the pointer 300, using the picked-up image information.

The storage unit 180 is a computer-readable recording medium. The storage unit 180 stores a program which prescribes operations of the projector 100, and various kinds of information (for example, image information used by the image combining unit 121).

Of the image information used by the image combining unit 121, the calibration pattern information and the distortion correction pattern information will now be described. In this embodiment, the first pattern information and the second pattern information are used as the calibration pattern information.

FIG. 5 shows a first pattern P1 corresponding to the first pattern information. In the first pattern P1, a white rectangular pattern P1b is superimposed on a black background P1a. FIG. 6 shows a second pattern P2 corresponding to the second pattern information. The second pattern P2 is an entirely black image. The first pattern P1 and the second pattern P2 are used for calibration.

The patterns for calibration are not limited to the patterns shown in FIGS. 5 and 6 and can be changed where appropriate. The patterns for calibration may be crosshatched patterns or patterns formed in consideration of the influence of camera lens distortion.

In calibration, the image pickup unit 160 changes the filter 162 transmitting only infrared light to a filter transmitting visible light and thus picks up an image. Then, panel coordinates and CMOS coordinates are associated with each other, using picked-up image information generated by this image pickup.

In this case, for example, at least one of a parameter for correcting a difference in optical characteristics between the filter 162 for infrared light and the filter for visible light and a parameter for correcting the height of the position of the light emission at the tip of the pen of the pointer 300 may be provided, and the projector 100 may specify the designated position designated by the pointer 300, taking this parameter into consideration.

Meanwhile, instead of using patterns for calibration, the projector 100 may be configured to perform calibration by sequentially displaying M×N points on the projection surface 200 and allowing the pointer 300 to sequentially touch these points. In this case, there is no need to change the filter 162 for infrared light to the filter for visible light.

FIG. 7 shows a distortion correction pattern P3 corresponding to the distortion correction pattern information.

In the distortion correction pattern P3, a cross pattern P3a representing a cross which quadrisects the rectangular distortion correction pattern P3 and a circle pattern P3b are shown. The cross pattern P3a functions as the boundaries of the four areas I1 to I4 of the projection image I. The center of the cross pattern P3a and the center of the circle pattern P3b are situated at a center P3c of the distortion correction pattern P3.

Each of the cross pattern P3a and the circle pattern P3b is displayed in the distortion correction pattern P3 in such a way that the user can easily recognize the degree of distortion in the projected distortion correction pattern P3 (projection image I). For example, if the cross pattern P3a is not formed by a vertical line and a horizontal line in the projection image I, the user can recognize that the projection image I is distorted. Also, if the circle pattern P3b is distorted in the projection image I, the user can recognize that the projection image I is distorted.

In the distortion correction pattern P3, a white cross pattern P3a and a white circle pattern P3b are displayed on a blue background.

The patterns shown in the distortion correction pattern P3 are not limited to the patterns shown in FIG. 7 and the foregoing colors and can be changed where appropriate.

The image information used by the image combining unit 121 may be generated by executing a program, instead of being stored in the storage unit 180 in advance.

Back to FIG. 3, the control unit 190 is a computer such as a CPU (central processing unit). The control unit 190 reads and executes a program stored in the storage unit 180 and thus implements a mode control unit 191, a projection control unit 192, an image pickup control unit 193, a calibration execution unit 194, a position detection unit 195, a display control unit 196, a movement detection unit 197, and a correction amount calculation unit 198. The control unit 190 works with the image distortion correction unit 122 and thus implements a correction unit 100b.

The mode control unit 191 controls operation modes of the projector 100. The projector 100 has a “normal mode” and a “distortion correction mode” as operation modes.

The normal mode is, for example, a mode in which a projection image corresponding to image information is projected. In the normal mode, distortion correction is not executed. In the distortion correction mode, distortion correction is executed.

The mode control unit 191 sets the “distortion correction mode” as the operation mode, for example, if the operation unit 110 receives an operation of starting distortion correction (hereinafter also referred to as “distortion correction start operation”). The mode control unit 191 sets the “normal mode” as the operation mode, for example, if the operation unit 110 receives either an operation of starting the normal mode (hereinafter also referred to as “normal mode start operation”) or an operation of ending distortion correction (hereinafter also referred to as “distortion correction end operation”).

The projection control unit 192 controls the light source drive unit 140 and thus controls the projection of the projection image I by the projection unit 150.

The image pickup control unit 193 controls the image pickup of the projection surface 200 by the image pickup unit 160.

The calibration execution unit 194 executes calibration using the first pattern P1 and the second pattern P2. In this embodiment, the calibration execution unit 194 generates a homography matrix for transforming coordinates (position) on the liquid crystal light valves 152 into coordinates (position) on the image pickup element 163, using the first pattern P1 and the second pattern P2. The calibration execution unit 194 stores the homography matrix into the storage unit 180.

The position detection unit 195 repeatedly detects a designated position designated by the pointer 300, based on picked-up image information. In this embodiment, the position detection unit 195 detects the position of the light emitting unit 320 on a picked-up image, as the designated position designated by the pointer 300.

The display control unit 196 controls the display of an image such as the projection image I. For example, the display control unit 196 causes the display form of at least a part of the designated area to be different from the display form of an area that is different from the designated area, of the areas I1 to I4. In this embodiment, the display control unit 196 causes the background color of the designated area to be different from the background color of the area that is different from the designated area.

The movement detection unit 197 detects a movement of the pointer 300, based on a change in the designated position designated by the pointer 300 detected repeatedly by the position detection unit 195. In this embodiment, the movement detection unit 197 detects whether the pointer 300 is in contact with the projection surface 200 or not, based on the result of light reception by the light receiving unit 170. The movement detection unit 197 detects a movement of the pointer 300 if the distal end 301 of the pointer 300 is in contact with the projection surface 200.

The correction amount calculation unit 198 calculates a parameter for image distortion correction, based on the designated position designated by the pointer 300 detected by the position detection unit 195 and the movement of the pointer 300 detected by the movement detection unit 197. The correction amount calculation unit 198 sets the parameter for image distortion correction to the image distortion correction unit 122. The image distortion correction unit 122 executes image distortion correction of the image information according to the parameter for image distortion correction.

The correction amount calculation unit 198 and the image distortion correction unit 122 are included in the correction unit 100b. The correction unit 100b corrects a distortion of the projection image I, based on the designated position designated by the pointer 300 and the movement of the pointer 300. The correction amount calculation unit 198 and the image distortion correction unit 122 may be included in the same component unit. For example, the image distortion correction unit 122, together with the correction amount calculation unit 198, may be included in the control unit 190.

Operations will now be described.

First, calibration will be described.

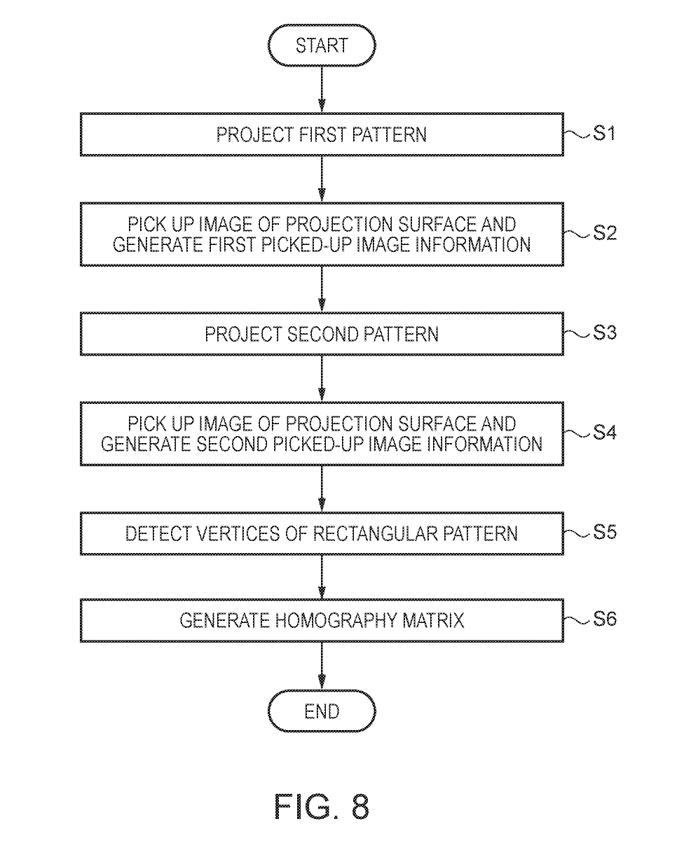

FIG. 8 is a flowchart for explaining calibration. In the description below, it is assumed that the light source 151 emits light and that image information is not written on the first layer of the image combining unit 121.

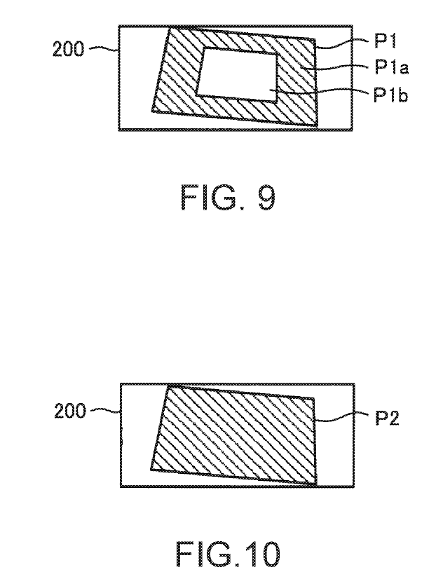

When the operation unit 110 receives an operation of starting calibration (hereinafter also referred to as “calibration start operation”) from the user, the calibration execution unit 194 reads first pattern information from the storage unit 180 and writes the first pattern information on the second layer. When the first pattern information is written on the second layer, the image processing unit 120 generates an image signal corresponding to the first pattern information. Based on this image signal, the projection unit 150 projects the first pattern P1 (see FIG. 5) on the projection surface 200 (step S1). FIG. 9 shows an example of the projection of the first pattern P1 on the projection surface 200.

Next, the image pickup control unit 193 causes the image pickup unit 160 to pick up an image of the projection surface 200 and to generate first picked-up image information (step S2). The image pickup unit 160 then outputs the first picked-up image information to the calibration execution unit 194.

Next, the calibration execution unit 194 reads second pattern information from the storage unit 180 and writes the second pattern information on the second layer. When the second pattern information is written on the second layer, the image processing unit 120 generates an image signal corresponding to the second pattern information. Based on this image signal, the projection unit 150 projects the second pattern P2 (see FIG. 6) on the projection surface 200 (step S3). FIG. 10 shows an example of the projection of the second pattern P2 on the projection surface 200.

Next, the image pickup control unit 193 causes the image pickup unit 160 to pick up an image of the projection surface 200 and to generate second picked-up image information (step S4). The image pickup unit 160 then outputs the second picked-up image information to the calibration execution unit 194.

Next, the calibration execution unit 194 takes the difference between the first picked-up image information and the second picked-up image information and detects a rectangular pattern P1b (see FIG. 9). The calibration execution unit 194 then detects the coordinates of the four vertices of the rectangular pattern P1b in the picked-up image (step S5).

Next, calibration execution unit 194 calculates a homography matrix, based on the positional relation between the coordinates of the four vertices of the rectangular pattern P1b specified by the first pattern information (coordinates of the four vertices of the rectangular pattern P1 on the liquid crystal light valves 152) and the coordinates of the four vertices of the rectangular pattern P1b in the picked-up image (step S6). The homography matrix is an example of the result of calibration. Applying the homography matrix on the coordinates on the liquid crystal light valves 152 transforms the coordinates on the liquid crystal light valves 152 into coordinates on the picked-up image.

Operations in the distortion correction mode will now be described.

When the operation unit 110 receives the distortion correction start operation, the mode control unit 191 sets the “distortion correction mode” as the operation mode.

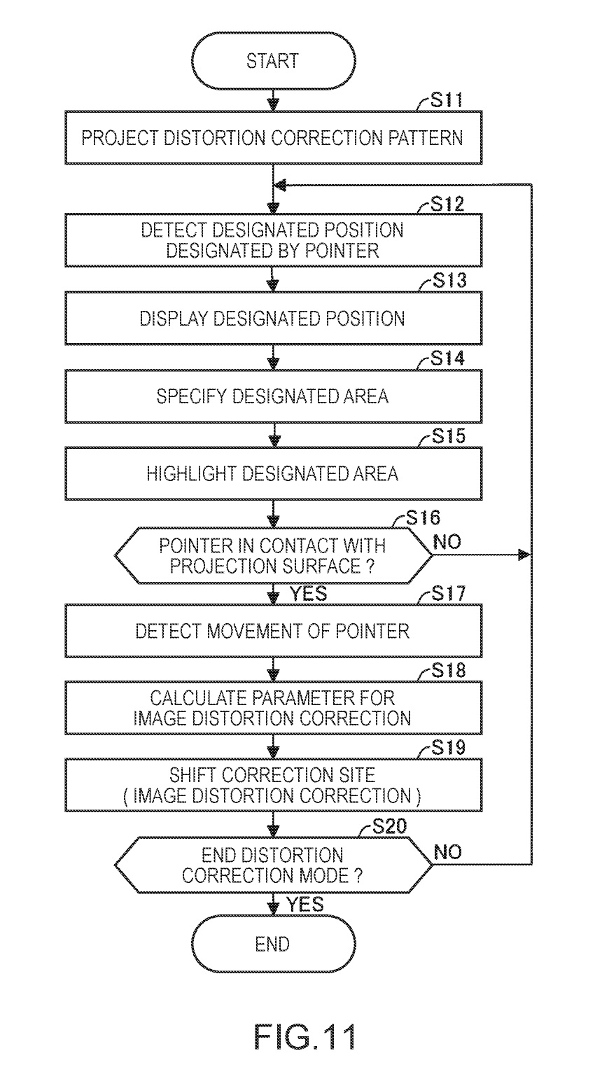

FIG. 11 is a flowchart for explaining image distortion correction in the distortion correction mode.

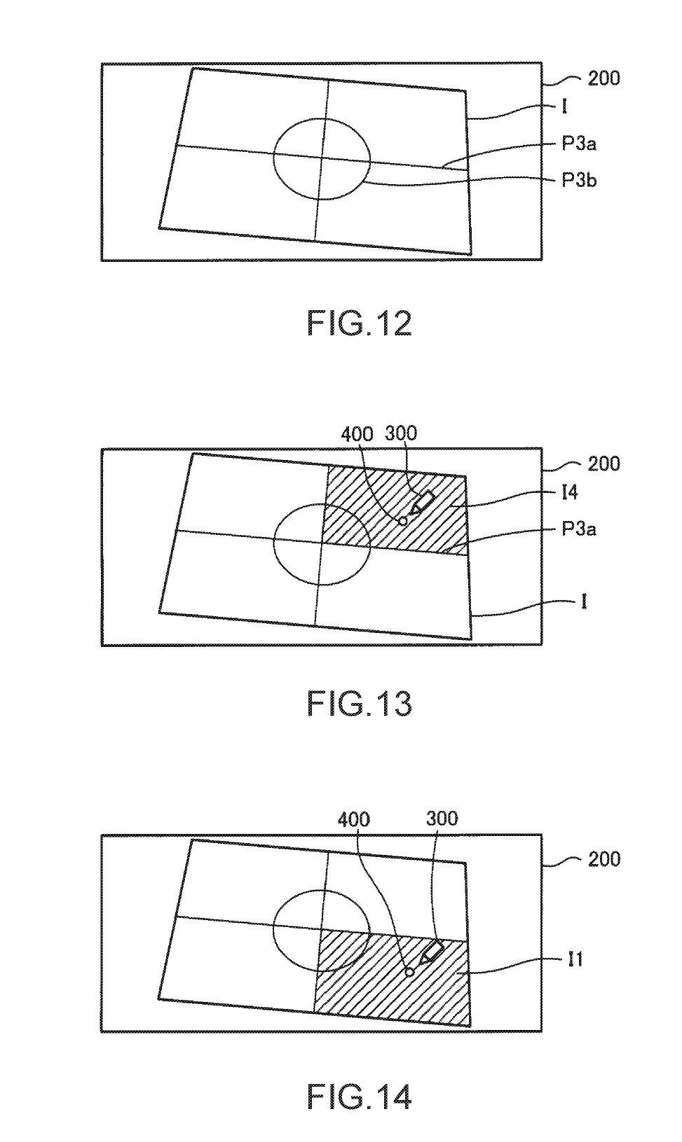

In the distortion correction mode, the projection control unit 192 reads distortion correction pattern information from the storage unit 180 and writes the distortion correction pattern information on the second layer. When the distortion correction pattern information is written on the second layer, the image processing unit 120 generates an image signal corresponding to the distortion correction pattern information. Based on this image signal, the projection unit 150 projects the distortion correction pattern P3 (see FIG. 7) on the projection surface 200 (step S11). FIG. 12 shows the projection image I of the distortion correction pattern P3 projected on the projection surface 200.

Next, the image pickup control unit 193 causes the image pickup unit 160 to pick up an image of the projection surface 200 and to generate picked-up image information. The position detection unit 195 analyzes the picked-up image information generated by the image pickup unit 160 in the distortion correction mode and detects the designated position designated by the pointer 300 (step S12). In step S12, the position detection unit 195 detects the position of the light emitting unit 320 on the picked-up image, as the designated position designated by the pointer 300.

Next, the display control unit 196 displays the designated position designated by the pointer 300 in the projection image I (step S13).

In step S13, the display control unit 196 first calculates an inverse matrix of a homography matrix. The display control unit 196 then transforms the designated position designated by the pointer 300 on the picked-up image into a position on the liquid crystal light valves 152, using the inverse matrix. The display control unit 196 then generates marker image information which represents an image showing a marker 400 at the designated position designated by the pointer 300 on the liquid crystal light valves 152. Therefore, the marker 400 shows the designated position designated by the pointer 300. The display control unit 196 then writes the marker image information on the first layer. When the marker image information is written on the first layer, the image processing unit 120 generates an image signal corresponding to the image showing the marker 400 on the distortion correction pattern P3. The projection unit 150 projects an image corresponding to the image signal onto the projection surface 200.

Since the marker 400 is displayed in the projection image I, the user can easily recognize the designated position designated by the pointer 300 (see FIG. 13). The user shifts the designated position designated by the pointer 300 to an area where there is a point which the user wants to correct (one of the points C1 to C4), of the areas I1 to I4.

In the projector 100, the display control unit 196 specifies a designated area (step S14).

In step S14, the display control unit 196 transforms the position of the distortion correction pattern P3 on the liquid crystal light valves 152 into a position on the picked-up image, using the homography matrix.

Next, the display control unit 196 specifies a designated area including the designated position designated by the pointer 300, from among the areas I1 to I4 on the picked-up image.

The display control unit 196 then highlights the designated area (step S15).

In step S15, the display control unit 196 changes the background color of the designated area from blue to green, in the distortion correction pattern P3 written on the second layer.

FIG. 13 shows an example where the area I4, which is the designated area, is highlighted. In FIG. 13, the area I4 highlighted in green is hatched. FIG. 13 also shows that the marker 400 is displayed at the designated position designated by the pointer 300.

Since the designated area is highlighted, the user can easily recognize whether the area where the designated position designated by the pointer 300 exists has become the designated area or not.

The user changes the designated position designated by the pointer 300 in such a way that the designated position designated by the pointer 300 is included in the designated area. When the designated position designated by the pointer 300 is included in the designated area, the user brings the pointer 300 into contact with the designated area and then shifts the pointer 300, in order to execute image distortion correction to shift the correction site. The direction of this shift is used to decide the direction of shift of the correction site. The magnitude of this shift is used to decide the amount of shift of the correction site.

In the projector 100, the movement detection unit 197 determines whether the pointer 300 is in contact with the projection surface 200 or not (step S16).

In step S16, if the light receiving unit 170 receives infrared light in the first light emission pattern, the movement detection unit 197 determines that the pointer 300 is in contact with the projection surface 200. Meanwhile, if the light receiving unit 170 receives infrared light in the second light emission pattern, the movement detection unit 197 determines that the pointer 300 is not in contact with the projection surface 200 (hovering state).

If the pointer 300 is not in contact with the projection surface 200 (NO in step S16), the processing returns to step S12 and a designated position is detected again. FIG. 14 shows an example where the designated area is changed from the area I4 to the area I1 by a shift or the like of the pointer 300.

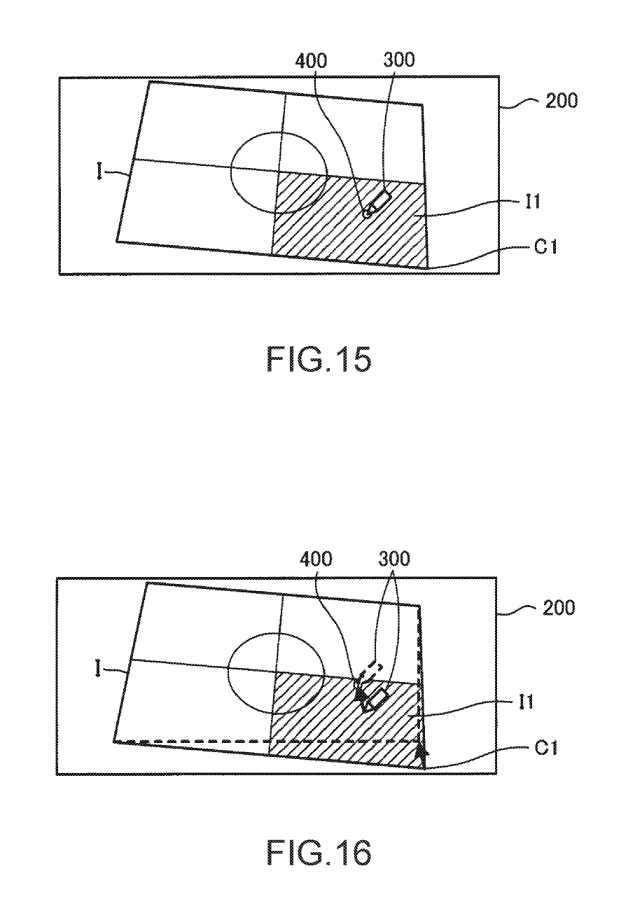

If the pointer 300 is in contact with the projection surface 200 (YES in step S16), the designated position designated by the pointer 300 coincides with the position of the marker 400, and the movement detection unit 197 detects a movement of the pointer 300 (step S17). FIG. 15 shows an example where the pointer 300 is in contact with the projection surface 200 in the area I1. Here, the timing when it is detected that the pointer 300 is in contact with the projection surface 200 is an example of the timing when the pointer 300 comes into contact with the projection surface 200, and is also an example of a first timing.

In step S17, while the light receiving unit 170 continues receiving infrared light in the first light emission pattern, that is, while the pointer 300 is in contact with the projection surface 200, the movement detection unit 197 detects the direction of a movement of the pointer 300 and the magnitude of the movement of the pointer 300, based on the transition of the designated position detected by the position detection unit 195. That is, the position detection unit 195 detects the designated position designated by the pointer 300 even at the timing corresponding to when the pointer 300 comes into contact with the projection surface 200, whereas the movement detection unit 197 detects the movement of the pointer 300 occurring after the timing when it is detected that the pointer 300 is in contact with the projection surface 200 (after the first timing).

Next, the correction amount calculation unit 198 calculates a parameter for image distortion correction, based on the designated position detected by the position detection unit 195 and the movement of the pointer 300 detected by the movement detection unit 197 (step S18).

In step S180, the correction amount calculation unit 198 first decides, as a correction site, a point included in the designated area from among the points C1 to C4 at the four corners of the projection image I.

The correction amount calculation unit 198 then decides a direction of shift of the correction site according to the direction of the movement of the pointer 300, and decides an amount of shift of the correction site according to the magnitude of the movement of the pointer 300.

For example, the correction amount calculation unit 198 uses the direction of the movement of the pointer 300, as the direction of shift of the correction site. The correction amount calculation unit 198 also decides a value (hereinafter also referred to as “amount of shift”) obtained by multiplying the magnitude of the movement of the pointer 300 by a constant A (for example, constant A=1), as the amount of shift of the correction site. The constant A is not limited to 1 and can be changed where appropriate.

Next, the correction amount calculation unit 198 calculates a parameter for image distortion correction to shift the correction site by the amount of shift of the correction site in the direction of shift of the correction site.

The correction amount calculation unit 198 then shifts the correction site, using the parameter for image distortion correction, and thus executes image distortion correction (step S19).

In step S19, the correction amount calculation unit 198 sets the parameter for image distortion correction to the image distortion correction unit 122. The image distortion correction unit 122 shifts the correction site by the amount of shift of the correction site in the direction of shift of the correction site according to the parameter for image distortion correction and thus executes image distortion correction.

FIG. 16 shows an example of the correction of the projection image I corresponding to the shift of the designated position designated by the pointer 300. In FIG. 16, the contour of the projection image I after correction is indicated by dashed lines. An arrow in FIG. 16 indicates the movement of the distal end 301 of the pointer 300. Shifting the point C1 results in image distortion correction performed on the entirety of the projection image I.

Next, if the operation unit 110 receives a distortion correction end operation or a normal mode start operation, the mode control unit 191 ends the distortion correction mode (YES in step S20) and changes the operation mode to the normal mode.

Meanwhile, if the operation unit 110 receives neither a distortion correction end operation nor a normal mode start operation, the mode control unit 191 continues the distortion correction mode (NO in step S20) and the processing returns to step S12. As the processing returns to step S12, the user can execute image distortion correction, using a different point from the point C1.

With the projector 100 and the method for controlling the projector 100 according to this embodiment, a distortion of the projection image I is corrected based on a designated position designated by the pointer 300 and a movement of the pointer 300. This enables the user to intuitively correct the distortion of the projection image I, using the pointer 300. Thus, the distortion of the projection image I can be easily corrected and operability is improved.

### Modifications

The invention is not limited to the foregoing embodiment and can be modified in various manners, for example, as follows. Also, one or a plurality of modifications selected arbitrarily from the following modifications can be combined together where appropriate.

### Modification 1

The movement detection unit 197 in practice detects a movement of the light emitting unit 320 of the pointer 300, as a movement of the pointer 300.

However, the movement detection unit 197 may detect a movement other than a movement of the light emitting unit 320, as a movement of the pointer 300. For example, the movement detection unit 197 may detect a movement of the attitude of the pointer 300, as a movement of the pointer 300.

In this case, the pointer 300 has, for example, an attitude detection unit with a gyro sensor, an attitude detection start button, and a transmitting unit. When the attitude detection start button is pressed, the transmitting unit transmits the result of the subsequent detection by the attitude detection unit, to the projector 100.

The projector 100 has a receiving unit which receives the result of the detection by the attitude detection unit. The movement detection unit 197 detects a movement of the attitude of the pointer 300, based on the result of the detection by the attitude detection unit. Specifically, the movement detection unit 197 detects the direction of change in the attitude of the pointer 300 and the amount of change in the attitude of the pointer 300. The direction of change in the attitude of the pointer 300 is used as the direction of the movement of the pointer 300. The amount of change in the attitude of the pointer 300 is used as the magnitude of the movement of the pointer 300.

### Modification 2

The pointer 300 may have a laser pointer. In this case, the filter 162 shifts from the front of the image pickup element 163 and then returns to the front of the image pickup element 163 so that the image pickup unit 160 can also pick up an image of a laser beam emitted from the laser pointer and designating a point on the projection surface 200.

The position detection unit 195 may detect a designated position designated by a laser beam emitted from the laser pointer, based on picked-up image information generated by the image pickup unit 160.

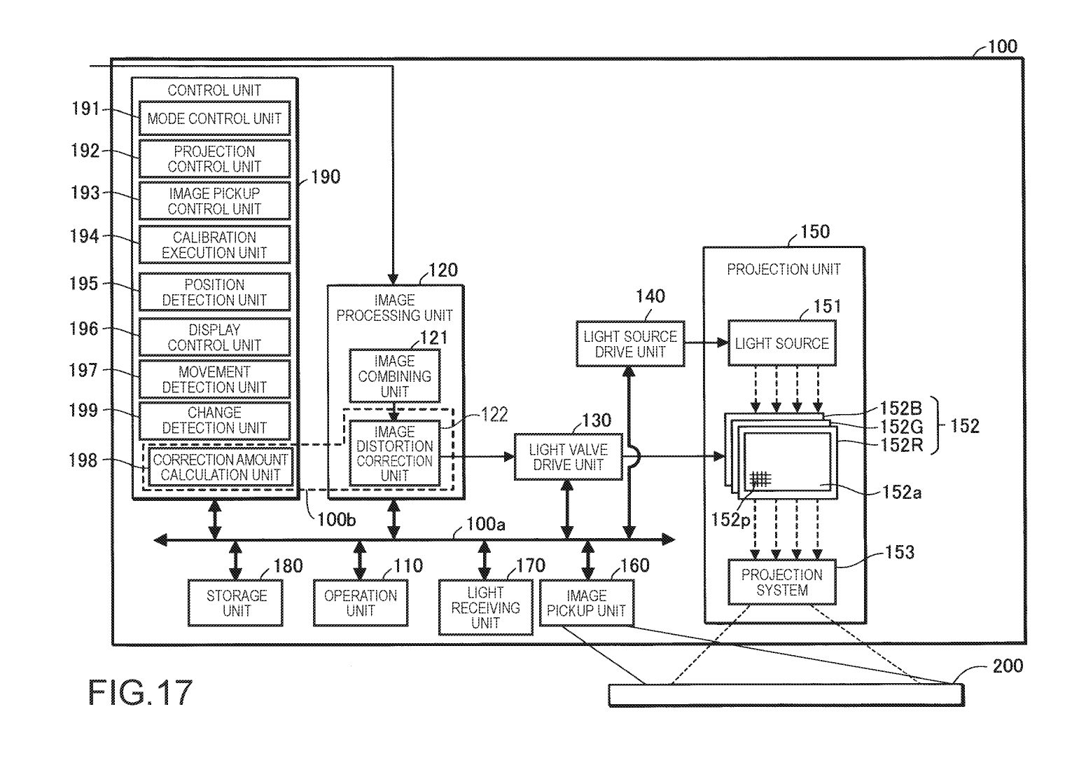

The projector 100 may also include a change detection unit 199, as shown in FIG. 17. The change detection unit 199 detects a change in the designated position designated by the laser beam on the projection surface 200, based on the picked-up image information generated by the image pickup unit 160. For example, the change detection unit 199 detects the direction of change in the designated position designated by the laser beam and the amount of shift of the designated position designated by the laser beam.

The correction amount calculation unit 198 calculates a parameter for image distortion correction, using the direction of change in the designated position designated by the laser beam, as the direction of the movement of the pointer 300, and using the amount of shift of the designated position designated by the laser beam, as the magnitude of the movement of the pointer 300.

When the projector 100 shown in FIG. 17 is used, a laser pointer may be used instead of the pointer 300. In this case, the movement detection unit 197 can be omitted.

### Modification 3

In the foregoing embodiment, the center position of the cross pattern P3a shifts with the execution of image distortion correction, as shown in FIGS. 1 and 2. However, the center position of the cross pattern P3a may be fixed at a specific position on the liquid crystal light valves 152, regardless of whether image distortion correction is executed or not.

### Modification 4

The highlighting of the designated area is not limited to changing the background color and can be changed where appropriate. For example, as the highlighting, a predetermined image (for example, an image showing a circle or a star) may be displayed at a part of the designated area (for example, the vicinity of the point included in the designated area, of the points C1 to C4). The predetermined image is not limited to an image showing a circle or a star. Any image that the user can visually recognize may be used.

The display control unit 196 may display a message to assist operations. An example of this message may be a message expressing a range where the correction site can be moved. The display control unit 196 may display a boundary indicating the range where the correction site can be moved in the projection image I, along with this message.

The background color of apart of the designated area may be changed, instead of changing the background color of the entirety of the designated area.

The movement detection unit 197 and the change detection unit 199 may simply detect a shift (change) of the designated position within the designated area.

### Modification 5

As distortion correction of a projection image, point correction in which a distortion of a projection image is corrected by position adjustment of each point of intersection of lines dividing the projection image into a lattice, curvature correction in which a curved projection image is adjusted, or arc correction in which arcuate correction is made on each of the top, bottom, left and right sides of a projection image or the like may be used, instead of keystone correction used in the embodiment.

### Modification 6

If an OSD image shows a menu image which enables switching one operation mode to another, the mode control unit 191 may change the operation mode according to an operation on the menu image. If an interactive tool bar including an icon or the like that can be operated by the pointer 300 is displayed, the mode control unit 191 may change the operation mode according to an operation on the interactive tool bar.

### Modification 7

Calibration is not limited to auto calibration, which is automatically carried out by the projector 100 as in the embodiment. Manual calibration may also be employed.

To execute manual calibration, the calibration execution unit 194 projects an image for manual calibration on the projection surface 200. A plurality of marks is displayed in the image for manual calibration. In manual calibration, the user designated, with the pointer 300, each of the marks in the image for manual calibration displayed on the projection surface 200. The calibration execution unit 194 detects an operation of the pointer 300 on the image for manual calibration, based on picked-up image information, and generates a homography matrix.

### Modification 8

The correction unit 100b may calculate a parameter for image distortion correction and set the parameter for image distortion correction, with the shift of the pointer 300, and thus execute distortion correction in real time.

The correction unit 100b may set a parameter for image distortion correction and execute distortion correction when a distortion correction end operation is received in the distortion correction mode. Also, the correction unit 100b may set a parameter for image distortion correction calculated up to this point and execute distortion correction when a distortion correction end operation is received in the distortion correction mode.

In the distortion correction mode, the correction unit 100b may display the projection image I before distortion correction and the projection image I after distortion correction. When a distortion correction end operation is received in the distortion correction mode, the correction unit 100b may delete the projection image I before distortion correction, leaving the projection image I after distortion correction.

### Modification 9

When image distortion correction is carried out, the marker 400 and the designated position designated by the pointer 300 shift from each other. To restrain this shift, the calibration execution unit 194 may automatically adjust the homography matrix, based on the image distortion correction, or may execute calibration again, when image distortion correction is carried out.

### Modification 10

The projector 100 may have an irradiation unit which casts layer-like detection light on the user's finger in contact with the projection surface 200. The irradiation unit emits layer-like (or curtain-like) detection light over the entire surface of the projection surface 200 in order to detect that a non-light-emitting pointer such as the user's finger is in contact with the projection surface 200. As the layer-like detection light, infrared light is used. Here, the term “layer-like” or “curtain-like” means a thin spatial shape with a substantially uniform thickness. The distance between the projection surface 200 and the layer-like detection light is set, for example, to a value within a range of 1 to 10 mm (preferable 1 to 5 mm).

In this case, the image pickup unit 160 picks up an image of the layer-like detection light reflected by the user's finger in contact with the projection surface 200 and generates picked-up image information.

When the user's finger is used as a pointer, the projector 100 can only determine whether the layer-like detection light is cast on the user's finger or not, that is, whether the user's finger is in contact with the projection surface 200 or not, with respect to the positional relation between the user's finger and the projection surface 200.

Therefore, for example, if the state where the user's finger is in contact with the projection surface 200 continues for a predetermined time (for example, 2 seconds), the position detection unit 195 detects a designated position designated by the user's finger and specifies a designated area based on the designated position. The predetermined time is not limited to 2 seconds and can be changed where appropriate. The timing when the state where the user's finger is in contact with the projection surface 200 has continued for a predetermined timing (for example, 2 seconds) is another example of the first timing. Alternatively, at the timing when it is detected that the user's finger come into contact with the projection surface 200 or has been in contact with the projection surface 200 for a predetermined time, the position detection unit 195 may cause the projection unit 150 to project a selection message such as “Decide a designated area? OK/NG” or the like and allow the user to select OK or NG by an operation of the finger, thus finalizing the designated area.

The movement detection unit 197 detects a movement of the user's finger, for example, after the state where the user's finger is in contact with the projection surface 200 continues for the predetermined time.

In this case, the display control unit 196 may change the display form of the marker 400 (for example, at least one of the color and shape of the marker 400) if the state where the user's finger is in contact with the projection surface 200 continues for a predetermined time, that is, if a distortion correction is available for execution. In this case, the user can recognize that distortion correction is available for execution, based on the display form of the marker 400.

### Modification 11

The projector 100 may include a stereo camera which picks up an image of the projection surface 200, and the position detection unit 195 may detect the position of the pointer 300, based on picked-up image information generated by the stereo camera. In this case, even if the projection surface 200 is not a flat surface but is a curved surface or a surface having at least a concave part and a convex part, when the pointer 300 shifts along the projection surface 200, the position detection unit 195 can detect the shift of the pointer 300.

### Modification 12

If the storage unit 180 stores image information, the image combining unit 121 may use the image information stored in the storage unit 180 instead of received image information.

### Modification 13

All or a part of the elements implemented by the control unit 190 executing a program may be implemented by hardware such as an electronic circuit like FPGA (field programmable gate array) or ASIC (application specific IC), or may be implemented by collaboration of software and hardware.

### Modification 14

While the projection unit 150 uses liquid crystal light valves as a light modulation device, the light modulation device is not limited to liquid crystal light valves and can be changed where appropriate. For example, the light modulation device may use three reflection-type liquid crystal panels. The light modulation device may employ a system using one liquid crystal panel, a system using three digital mirror devices (DMD), a system using one digital mirror device, or the like. If the light modulation device uses only one liquid crystal panel or DMD, components equivalent to the color separation system and the light combining system are not needed. Also, any configuration that can modulate light emitted from a light source, other than liquid crystal panel and DMD, can be employed as the light modulation device.

The entire disclosure of Japanese Patent Application No. 2017-204524, filed Oct. 23, 2017 is expressly incorporated by reference herein.

What is claimed is:

1. A projector comprising:
a projection unit which projects a projection image on a projection surface;
a position detection unit which detects a designated position designated by a pointer on the projection surface;
a movement detection unit which detects a movement of the pointer; and
a correction unit which corrects a distortion of the projection image, based on the designated position and the movement.

2. The projector according to claim 1, wherein
the correction unit
decides a correction site in the projection image, based on the designated position, and
corrects the position of the correction site, based on the movement, and thus corrects the distortion of the projection image.

3. The projector according to claim 2, wherein
the projection image has a plurality of areas,
the areas include a candidate of the correction site, and
the correction unit
specifies a designated area including the designated position from among the plurality of areas and
decides a candidate of the correction site included in the designated area, as the correction site.

4. The projector according to claim 3, further comprising
a display control unit which causes a display form of at least a part of the designated area to be different from a display form of an area that is different from the designated area, of the plurality of areas.

5. The projector according to claim 2, wherein
the correction unit
decides a direction of shift of the correction site according to a direction of the movement,
decides an amount of shift of the correction site according to a magnitude of the movement, and
shifts the correction site by the amount of shift of the correction site in the direction of shift of the correction site.

6. The projector according to claim 1, wherein
the position detection unit detects the designated position at a first timing, and
the movement detection unit detects the movement generated after the first timing.

7. The projector according to claim 6, wherein
the first timing is a timing corresponding to when the pointer comes into contact with the projection surface.

8. The projector according to claim 6, wherein
the first timing is a timing corresponding to when a state where the pointer is in contact with the projection surface has continued for a predetermined time.

9. The projector according to claim 1, wherein
the movement detection unit detects a movement of the pointer in a state where the pointer is in contact with the projection surface.

10. The projector according to claim 1, wherein
the movement detection unit detects a movement of an attitude of the pointer.

11. A projector comprising:
a projection unit which projects a projection image on a projection surface;
a position detection unit which detects a designated position designated by a pointer on the projection surface;
a change detection unit which detects a change in the designated position; and
a correction unit which corrects a distortion of the projection image, based on the designated position and the change in the designated position.

12. The projector according to claim 11, wherein
the correction unit
decides a correction site in the projection image, based on the designated position, and
corrects the position of the correction site, based on the change in the designated position, and thus corrects the distortion of the projection image.

13. A method for controlling a projector, the method comprising:
projecting a projection image on a projection surface;
detecting a designated position designated by a pointer on the projection surface;
detecting a movement of the pointer; and
correcting a distortion of the projection image, based on the designated position and the movement.
